(19) United States
(12) Patent Application Publication
(10) Pub. No.: US 2025/0260929 A1
(43) Pub. Date: Aug. 14, 2025

(54) CENTER AUDIO SPEAKER

(71) Applicant: Cinereo LLC, Kamuela, HI (US)

(72) Inventor: Matt Morgan, Kamuela, HI (US)

(73) Assignee: Cinereo LLC, Kamuela, HI (US)

(21) Appl. No.: 19/051,020

(22) Filed: Feb. 11, 2025

Related U.S. Application Data
(60) Provisional application No. 63/566,121, filed on Mar. 15, 2024.
(60) Provisional application No. 63/552,566, filed on Feb. 12, 2024.

(51) Int. Cl. H04R 5/04; H04R 1/02; H04R 5/02

(52) U.S. Cl. CPC H04R 5/04; H04R 1/025; H04R 5/02; H04R 2499/15

(57) ABSTRACT

An audio system provides high quality center channel audio in a home-theater setting, or in other settings. In some cases, an audio receiver has a built-in center channel speaker. Multi-channel audio is provided from a smart display device to the audio receiver. The audio receiver extracts and downmixes the center channel audio and provides the center channel audio to the built-in center speaker. In some cases, the audio receiver also extracts and downmixes left and right channel audio and provides the left and right channel audio to external left and right channel speakers. In some cases, center channel audio is extracted, amplified, and provided to a passive center channel speaker.

### PRIORITY CLAIM

The present application claims priority to U.S. Provisional Patent Application No. 63/552,566, filed Feb. 12, 2024, titled “Three Channel Audio Receiver”. The present application claims priority to U.S. Provisional Patent Application No. 63/566,121, filed Mar. 15, 2024, titled “Center Audio Receiver”. U.S. Provisional Patent Application No. 63/552,566 and U.S. Provisional Patent Application No. 63/566,121 are incorporated herein by reference in their entireties. In cases where a document or website incorporated by reference herein conflicts with the present disclosure, the present disclosure controls.

### BACKGROUND

### Technical Field

The present disclosure is related to audio receivers, and, more particularly, to audio receivers utilizing a center channel.

### SUMMARY

In some embodiments, an audio receiver receives multi-channel home theater audio data via the HDMI protocol. The received audio signal is processed and down-mixed into three full-range audio channels—left, center, and right—along with a dedicated subwoofer channel. The left, center, and right channels are amplified to drive speaker drivers either directly or via a pre-amplified line-level output for use with external amplification. The center channel output is specifically designed to drive an enclosed full-range driver, ensuring coherent audio reproduction with high intelligibility, particularly for dialogue. The audio receiver may be termed a 3.1 audio receiver.

In some embodiments, an audio receiver receives multi-channel home theater audio data via the HDMI protocol. The received signal is processed and further down-mixed into a single full-range center channel and a dedicated subwoofer channel. The center channel output is amplified to drive a single enclosed full-range speaker, ensuring coherent audio reproduction with high intelligibility, particularly for dialogue. The subwoofer channel is provided as a line-level output for connection to an external powered subwoofer. This embodiment simplifies the audio system while maintaining clear and balanced sound reproduction. The audio receiver may be termed a 1.1 audio receiver.

In some embodiments, a passive center speaker box includes a non-amplified passive center speaker designed to reproduce clear and intelligible dialogue. The speaker incorporates a full-range driver enclosed within an acoustically optimized housing to ensure coherent sound reproduction. The passive design utilizes an external amplifier to drive the speaker, receiving a speaker-level signal from an AV receiver, amplifier, or external processing unit. The full-range driver is engineered to deliver a balanced frequency response, minimizing distortion and enhancing vocal clarity for home theater applications.

In some embodiments, an audio device includes an audio input module configured to receive multi-channel home theater audio data from a smart display device. In one example, the multi-channel audio data is 5.1 audio data. The audio input module downmixes audio data into center channel audio data. The audio device includes a center channel speaker and a single-channel amplifier coupled between the audio input module and the center channel speaker. The center channel audio data is amplified and provided to the center channel speaker.

In some embodiments, an audio device includes an audio input module configured to receive center channel audio data from a smart display device. The audio device includes a center channel speaker and a single-channel amplifier coupled between the audio input module and the center channel speaker. In some embodiments, the center channel speaker includes a full range driver.

In some embodiments, an audio device includes an audio input module configured to receive multi-channel audio data from a smart display device. In one example, the multi-channel audio data is 5.1 audio data. The audio input module downmixes the audio data into left, right, and center channel audio data. The audio device includes a center channel speaker and a three-channel amplifier coupled between the audio input module and the center channel speaker. The center channel audio data is amplified and provided to the center channel speaker.

In some embodiments, an audio device includes an audio input module configured to receive left, right, and center channel audio data from a smart display device. The audio device includes a center channel speaker, a left channel output port, and a right channel output port. The audio device includes a three-channel amplifier coupled to the between the audio input module and the center channel speaker, the left channel output port, and the right channel output port. The center channel speaker includes a full range driver.

In some embodiments, a passive center channel speaker box includes a housing including a front face and a back face. The passive center channel speaker box includes a full-range driver mounted in the front face. The passive center channel speaker box includes center channel input ports mounted in the back face and configured to receive amplified center channel audio signals and internal connection wires coupled between the center channel input ports and the full-range driver. The center channel speaker includes a full range driver.

In some embodiments, an audio device includes an audio input module configured to receive multi-channel audio data from a smart display device. The audio input module downmixes the audio data into left, right, and center channel audio data. The audio device includes a multi-channel amplifier coupled to the input module, a left channel output port coupled to the multi-channel amplifier, a right channel output port coupled to the multi-channel amplifier, and a center channel output port coupled to the multi-channel amplifier. The center channel speaker includes a full range driver. In some embodiments, an audio device includes an audio input module configured to receive left, right, and center channel audio data from a smart display device. The audio device includes a multi-channel amplifier coupled to the input module, a left channel output port coupled to the multi-channel amplifier, a right channel output port coupled to the multi-channel amplifier, and a center channel output port coupled to the multi-channel amplifier. The center channel speaker includes a full range driver.

In some embodiments, a method includes receiving, at an audio input module of an audio device, multi-channel audio data from a smart display device and extracting, with the audio input module, center channel audio data from the multi-channel audio data. The method includes converting, with a digital-to-analog converter of the audio device, the center channel audio data to center channel analog audio signals. The method includes generating, with an amplifier of the audio device, center channel amplified audio signals by amplifying the center channel analog audio signals and driving a center channel speaker of the audio device with the center channel amplified audio signals.

In some embodiments, an audio receiver provides left, right, and center channel audio signals to left, right, and center channel speakers. The audio receiver may receive audio signals from a smart display device via a wired connection that provides left, right, and center channel audio signals or data. The audio receiver then processes and provides the left, right, and center channel audio signals or data to the left, right, and center channel speakers, in some cases, after extracting these from a signal that contains them, such as an enhanced audio return channel (eARC) signal.

In some embodiments, the audio receiver includes left, right, and center output channel ports for providing audio signals or data to left, right, and center channel speakers. The audio receiver includes a digital audio converter and a multi-channel amplifier including power amplifiers for each of the left, right, and center channels.

In some embodiments, the audio receiver includes a built-in center speaker. A single channel amplifier provides the center channel audio to the built-in center speaker. The audio receiver includes one or more wireless communication modules to wirelessly provide left and right channel audio to external left and right channel speakers. In some embodiments, the audio receiver includes left and right pre-out ports to provide stereo audio for amplification by an external amplifier for external left and right speakers. In some embodiments, the audio receiver includes left and right channel amplified outputs to provide amplified left and right channel audio to external left and right channel speakers. The left and right channel audio can be amplified by amplifier internal to the audio receiver.

In some embodiments, the audio receiver includes an audio input module configured to receive left, right, and center channel audio signals from a smart display device. The audio receiver includes a center channel speaker. The audio receiver includes a three-channel amplifier configured to receive the left, right, and center channel audio signals and to generate amplified left, right, and center channel audio signals. The center channel speaker receives the amplified center channel audio signals. The audio receiver includes a left channel output port and a right channel output port configured to supply the amplified left channel audio signals and amplified right channel audio signals, respectively.

### BRIEF DESCRIPTION OF THE SEVERAL VIEWS OF THE DRAWINGS

Reference will now be made by way of example only to the accompanying drawings. In the drawings, identical reference numbers identify similar elements or acts. In some drawings, however, different reference numbers may be used to indicate the same or similar elements. The sizes and relative positions of elements in the drawings are not necessarily drawn to scale. For example, the shapes of various elements and angles are not necessarily drawn to scale, and some of these elements may be enlarged and positioned to improve drawing legibility.

FIG. 1 is a block diagram of an audio system including an audio receiver, in accordance with some embodiments.

FIG. 2 is a block diagram of internal components of an audio receiver, in accordance with some embodiments.

FIG. 3 is an illustration of an external face of an audio receiver including a plurality of input and output ports, in accordance with some embodiments.

FIG. 4 is an illustration of an audio system including the audio receiver of FIG. 3, in accordance with some embodiments.

FIGS. 5-8 are illustrations of audio systems including an audio receiver, in accordance with some embodiments.

FIG. 9 is an illustration of an audio system including an audio receiver with a built-in center speaker, in accordance with some embodiments.

FIG. 10 is a block diagram of internal components of the audio receiver of FIG. 9, in accordance with some embodiments.

FIG. 11 is an illustration of an external face of the audio receiver of FIG. 9 including a plurality of input and output ports, in accordance with some embodiments.

FIG. 12 is an illustration of an audio system including an audio receiver with a built-in center speaker, in accordance with some embodiments.

FIG. 13 is an illustration of a front face of an audio receiver with a built-in center speaker, in accordance with some embodiments.

FIG. 14 is an illustration of a back face of an audio receiver with a built-in center speaker, in accordance with some embodiments.

FIG. 15 is a block diagram of internal components of the audio receiver of FIG. 9, in accordance with some embodiments.

FIG. 16 is a block diagram of passive center channel speaker box, in accordance with some embodiments.

FIG. 17 is an illustration of a passive center channel speaker box, in accordance with some embodiments.

FIG. 18 is an illustration of a back face of a passive center channel speaker box with a built-in center speaker, in accordance with some embodiments.

FIG. 19 is a cross-sectional view of a passive center channel speaker box, in accordance with some embodiments.

FIG. 20 is an illustration of a passive center channel speaker box, in accordance with some embodiments.

FIG. 21 is an illustration of a passive center channel speaker box, in accordance with some embodiments

FIG. 22 is a cross-sectional view of a passive center channel speaker box, in accordance with some embodiments.

FIG. 23 is an illustration of a passive center channel speaker box, in accordance with some embodiments.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known audio receivers have not been shown or described in detail, to avoid unnecessarily obscuring descriptions of the embodiments. Further, well-known structures associated with audio receivers have not been shown or described in detail, to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.” Further, the terms “first,” “second,” and similar indicators of sequence are to be construed as interchangeable unless the context clearly dictates otherwise.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise. As used herein, the term “audio signal” can correspond to a digital audio signal or and analog audio signal.

In the following description, in some embodiments, multi-channel audio data (5.1, 7.1, or other audio data) is provided from a smart display device to an audio receiver, for example, by HDMI. The multi-channel audio data includes left, right, and center channel audio data, in addition to other channels (rear surround channels, etc.). An audio input module of the audio receiver extracts the left, right, and center channel audio data from the incoming signal. The audio receiver also downmixes audio data from other channels into the left, right, and center audio channels. The left, right, and center audio channels are then provided to speakers, amplifiers, pre-out ports, etc., as described in further detail below.

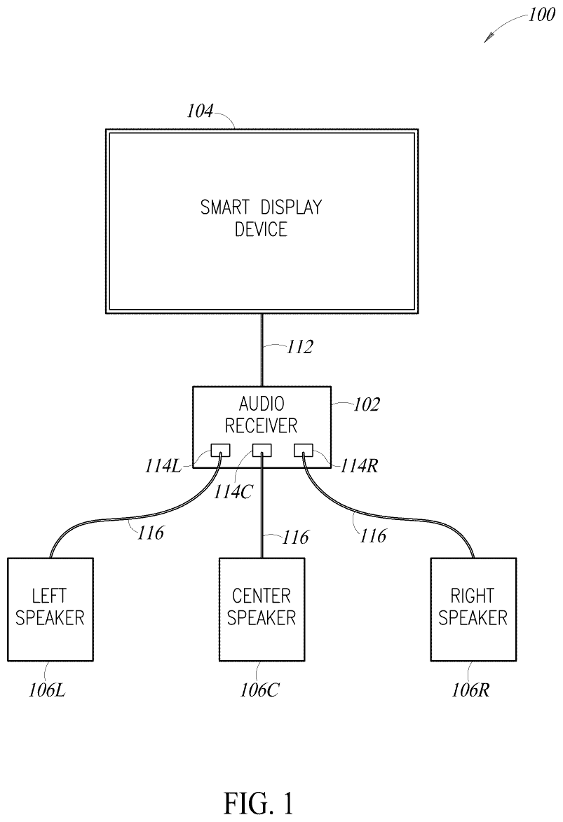

FIG. 1 is a block diagram of an audio system 100, in accordance with some embodiments. The system 100 is utilized to provide sound in a home setting, a commercial setting, or in other types of settings. The system 100 includes an audio receiver 102. As will be set forth in more detail below, the audio receiver 102 is able to provide high-quality sound via right, left, and center channel audio outputs.

There are many situations in which it is desirable to provide high-quality audio. For example, when watching video content such as a television program, a movie, or Internet content, the manner in which the accompanying audio content is provided can enhance or detract from the viewing experience.

Various conventional solutions can be utilized to provide audio content in which the inventor has identified drawbacks discussed below. For example, a home theater in a box may be utilized to facilitate providing surround sound in a living room of a home. This can include providing connections from the central box to a large number of speakers. Utilizing such a system may call for installation of a large number of speakers in particular locations throughout the viewing room. This can be an expensive process in which speakers are mounted with great particularity in various locations. The mounting process can call for removal of sections of walls to make place for speakers. The mounting process can call for installing expensive mounting fixtures on walls and ceilings. Furthermore, wiring such speakers can be complicated and expensive. In addition to expenditures of time and money, a large amount of space may be consumed and the living room or theater room may be dramatically altered. If removal of such a system is ever desired, it can be very difficult and complicated to restore the room to an original condition.

In addition to the drawbacks mentioned above, such systems often still provide a low-quality audio experience. The low-quality audio experience can result from spreading a budget over a large number of speakers, as well as from poor audio quality.

Another possible solution is to utilize a sound bar. A sound bar may include multiple speakers in a single housing positioned near a television or other display device. Utilizing a sound bar can result in poor audio quality. Furthermore, sound bars have limited upgrade options. Finally, sound bars may provide poor dialogue audio quality.

Another possible solution is a stereo system. However, stereo systems often provide very poor-quality dialogue audio due to crossover, spatial confusion, and coherence issues. Furthermore, there is no center channel for TV/movies. It can be very difficult to control the dialogue volume and tonality. Additionally, time alignment with respect to dialogue is compromised for listeners sitting away from the center position between the speakers.

The audio receiver 102 of FIG. 1, in accordance with principles of the present disclosure, overcomes many of the drawbacks of other possible solutions. The audio receiver 102 is able to provide high-quality audio in a manner that does not call for large numbers of speakers or expensive room alterations.

In some embodiments, the audio receiver 102 is configured to be coupled to a smart display device 104. The smart display device 104 can include a smart television, a projector, or other types of displays. The smart display device 104 renders video for television programs, movies, Internet videos, or other types of media. The smart display device 104 provides audio signals or data to the audio receiver 102.

In some embodiments, the smart display device 104 provides the audio signals to the audio receiver 102 via a connection 112. In some embodiments, the connection 112 is an HDMI cord coupled between the smart display device 104 and the audio receiver 102. Accordingly, the smart display device 104 may include an HDMI output, while the audio receiver 102 includes an HDMI input. The HDMI output of the smart display device 104 can provide audio data via an enhanced audio return channel (eARC) protocol, described in more detail at in the HDMI 2.1 specification release presentation document available at https://hdmiforum.org/wp-content/uploads/2017/11/HDMI-Forum-2.1-November-Release-Presentation-EN.pdf and incorporated by reference herein in its entirety. Use of the eARC protocol enables the smart display device 104 to provide high-quality audio data to the audio receiver 102 via an HDMI cord. The high-quality audio data can include high bit rate audio formats in multiple uncompressed channels. While the description may discuss with particularity examples in which the connection 112 is an HDMI cord with eARC, other types of connections between the smart display device 104 and the audio receiver 102 can be utilized without departing from the scope of the present disclosure.

In some embodiments, the audio receiver 102 includes three audio channel outputs 114. The three audio channel outputs 114 include a left audio channel output 114L, a right audio channel output 114R, and a center audio channel output 114C. The audio receiver 102 receives each audio channel via the connection 112 and provides audio to the corresponding audio channel outputs 114.

In some embodiments, the left audio channel output 114L is configured to be coupled to a left speaker 106L. The right audio channel output 114R is configured to be coupled to a right speaker 106R. The center audio channel output 114C is configured to be coupled to a center speaker 106C.

The audio receiver 102 provides a three-channel audio experience to accompany video content such as television programs or movies. This can be highly beneficial in providing the accompanying music of a video program in a very high-quality manner. Furthermore, the dedicated center channel enables particularly high-quality audio for the dialogue that accompanies a video program. The overall audio experience is greatly improved compared to other possible solutions.

The audio receiver 102 provides various other benefits in comparison to other solutions. In particular, the set-up of a high-quality audio system can be accomplished in a few minutes without expensive alterations to a room. In some cases, the audio receiver 102 need only be plugged into a power supply, coupled to the smart display device 104 via the connection 112, and then coupled to left, right, and center speakers via three connectors 116. Furthermore, removal or replacement of the audio receiver 102 and connected components can be accomplished in a few moments.

In some embodiments, the audio receiver 102 can be utilized to provide high-quality audio for music separate from any video content. The left and right output channels enable a high-quality stereo music listening experience via the audio receiver 102. Audio signals can be provided to the audio receiver 102 via wireless or wired connections. For example, the audio receiver 102 may include ports for wired connections to a turn table, a CD player, or other types of devices that can provide audio signals to the audio receiver 102. The audio receiver 102 can also include one or more wireless transceivers and corresponding software and circuitry to enable wireless communication with a smart phone or other devices that can provide audio signals to the audio receiver 102.

In some embodiments, the audio receiver 102 includes a streamer. The streamer can receive audio content via the Internet or other types of network connections, such as via a Wi-Fi radio or Ethernet connector of the audio receiver 102. The streamer can receive audio content from Internet-based audio streaming services. The audio receiver 102 can then output streamed music in a high-quality stereo experience via the left speaker 106 and the right speaker 106R.

In some embodiments, the audio receiver 102 includes a subwoofer output channel. The subwoofer output channel enables a subwoofer speaker to be easily connected to the audio receiver 102 via a connector (not shown). The audio receiver 102 can also include other types of output ports.

In some embodiments, the volume of the sound provided via the audio receiver 102 can be controlled by controlling the smart display device 104. A user utilizing a remote control (or manual control) for the smart display device 104 can control the audio volume. The eARC functionality of the HDMI channel (or other type of connector, as the case may be) provides data indicating the volume with which the sound should be provided from the audio receiver 102 to the speakers 106. The volume of the left, right, and center channels may be controlled individually, as well as time delay and equalization.

In some embodiments, the volume of sound provided via the audio receiver 102 can be controlled by a remote-control device that communicates directly with the audio receiver 102. For example, if an individual is streaming music from a smart phone to the audio receiver 102, the user may control the audio receiver 102 via the smart phone or via a separate remote control. The volume of the left, right, and center channels may be controlled individually.

In some embodiments, the audio receiver 102 includes one or more manual inputs. The one or more manual inputs can include a power button configured to determine the audio receiver 102 on or off. The one or more manual inputs can include a volume control for manually adjusting the volume of audio provided from the audio receiver 102. The one or more manual inputs can include controls for individually adjusting the audio of the left, right, and center channels. Other types of manual inputs can be utilized without departing from the scope of the present disclosure.

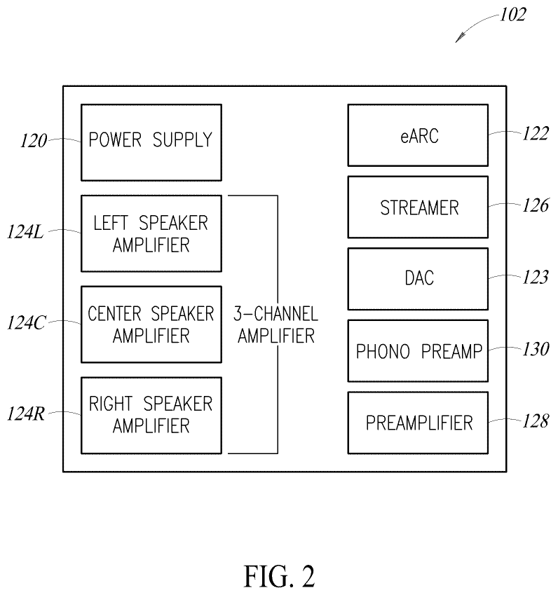

FIG. 2 is a block diagram of an audio receiver 102, in accordance with some embodiments. The audio receiver 102 of FIG. 2 is one example of an audio receiver 102 of FIG. 1.

The audio receiver 102 includes a power supply 120. The power supply 120 can correspond to an input by which an AC or DC voltage is provided to the audio receiver 102 from an external source. The external source can include a wall outlet or other type of power source. An untransformed AC voltage may be provided directly from a wall outlet to the power supply 120. The power supply 120 may include an internal transformer and rectifier to transform the AC voltage to a lower amplitude AC voltage, and then to rectify the lower amplitude AC voltage to a DC voltage. The DC voltage can be utilized to power the various components of the audio receiver 102. Alternatively, an AC voltage may be transformed and rectified externally and then provided to the power supply 120.

In some embodiments, the audio receiver 102 includes an eARC module 122. The eARC module 122 receives audio signals via the eARC of an HDMI connection. The eARC module 122 can include hardware and software resources for receiving and processing the audio signals and providing the audio signals, including the various audio channels, to other components of the audio receiver 102. The eARC module can perform processing or conditioning of the received audio signals. The eARC module 122 is one example of an audio input module. Other types of audio input modules can be utilized without departing from the scope of the present disclosure.

In some embodiments, the audio receiver 102 includes a digital audio converter (DAC) 123. The digital audio converter 123 receives digital audio signals from the eARC module 122 (or another module). The digital audio converter 123 converts the digital audio signals to analog audio signals. Accordingly, the digital audio converter 123 may correspond to or include a digital-to-analog converter. The digital audio converter 123 can include one or more digital filters, one or more low-pass filters, or other types of signal conditioning components or functionalities. The digital audio converter 123 can convert the audio associated with each channel of the incoming audio signal. The digital audio converter 123 can include other components or functionality without departing from the scope of the present disclosure. Although a single DAC 123 is illustrated in FIG. 2, multiple DACs can be implemented in the audio receiver 102.

In some embodiments, the audio receiver 102 includes a left speaker amplifier 124L, a center speaker amplifier 124C, and a right speaker amplifier 124R. Each channel amplifier 124 receives a corresponding analog audio signal from the DAC 123. For example, the left speaker amplifier 124L receives a left channel analog audio signal from the DAC 123. The right speaker amplifier 124R receives right channel analog audio signals from the DAC 123. The center speaker amplifier 124C receives center channel audio signal from the DAC 123. The right, left, and center amplifiers 124 may correspond to a three-channel amplifier. Other amplifiers can be included without departing from the scope of the present disclosure.

The right channel amplifier 124R amplifies the right channel analog audio signal and provides the amplified right channel audio signal to the right channel output 114R. The left channel amplifier 124L amplifies the left channel analog audio signal and provides the amplified left channel audio signal to the left channel output 114L. The center channel amplifier 124C amplifies the center channel analog audio signal and provides the amplified center channel audio signal to the center channel output 114C.

In some embodiments, the audio receiver 102 includes a streamer 126. As described previously, the streamer 126 enables the audio receiver 102 to receive audio signals from a wireless network connection. The streamer 126 can enable the audio receiver 102 to receive audio signals from an Internet-based audio streaming service. The streamer 126 can enable the audio receiver 102 to receive audio signals from a local device such as a smart phone, a tablet, a music server controlled remotely by handheld, or other device that may provide audio signals to the audio receiver 102 for high-quality output. The streamer 126 can include one or more wireless transceivers, processing resources, memory resources, or other software or hardware resources. The streamer can provide audio signals to the DAC 123.

In some embodiments, the audio receiver 102 includes a preamplifier 128. The preamplifier can correspond to an electronic amplifier that converts a weak analog audio signal into an output signal that is strong enough to be sufficiently noise tolerant for further processing. In some embodiments, the preamplifier 128 can receive analog audio signals from a phonograph or from another device directly connected to the audio receiver 102. The preamplifier 128 can provide an output signal to one or more of the amplifiers 124 or to other amplifiers prior to being output to a speaker.

In some embodiments, the audio receiver 102 includes a phono preamplifier 130. The other receiver 102 may include one or more ports for connecting to an external turntable such as a record player or other type of turntable. The audio provided from the turntable is received by the phono preamplifier 130. The phono preamplifier 130 amplifies the received audio signal to a level that can be processed by other components of the audio receiver 102. For example, the amplified signal from the phono preamplifier 130 may be provided to a power amplifier of the audio receiver 102 such as one of the channel amplifiers 124.

The audio receiver 102 can include other components than those shown in FIG. 2. The audio receiver 102 can include various other types of circuitry associated with receiving, processing, and outputting digital or analog audio signals, as will be understood by those of skill in the art. In some embodiments, the audio receiver 102 can include one or more processors including microcontrollers, microprocessors, or other types of processors. In some embodiments, the audio receiver 102 can include one or more memories configured to store data or software instructions associated with the functionality of the audio receiver 102. The one or more processors can execute software instructions or other data stored in the one or more memories to perform or to control performance of the functions of the audio receiver 102.

In some embodiments, the audio receiver 102 includes a software application that enables the audio receiver 102 to be communicatively coupled to an external electronic device that includes a companion software application. For example, a smart phone or tablet may include a software application that enables communication with the audio receiver 102. The audio receiver 102 likewise includes a software application installed therein.

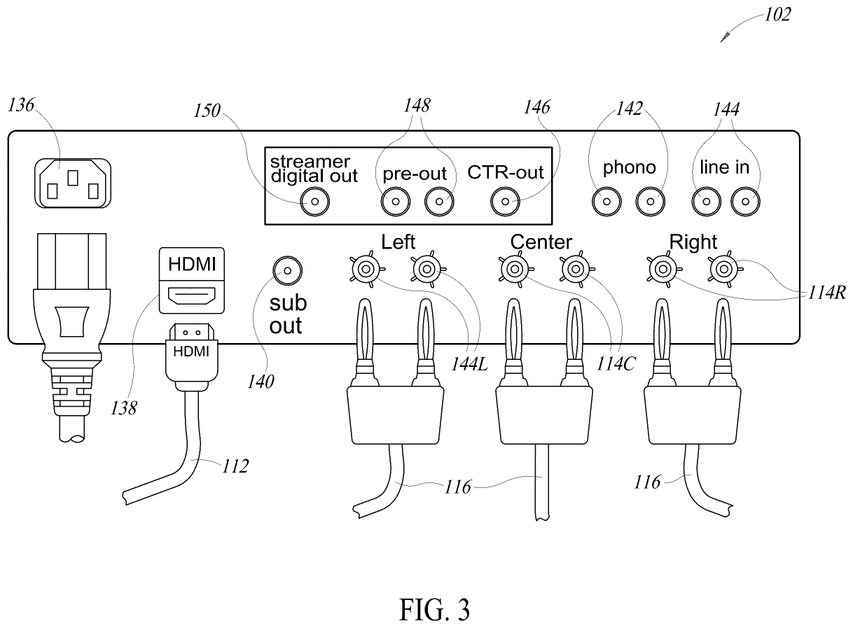

FIG. 3 is an illustration of a portion of an audio receiver 102, in accordance with some embodiments. The audio receiver 102 of FIG. 3 is one example of an audio receiver 102 of FIGS. 1 and 2. The view of FIG. 3 corresponds to a view of a backside of the audio receiver 102, in accordance with some embodiments. Components shown in FIG. 3 can be located on other sides or at other locations on the audio receiver 102 without departing from the scope of the present disclosure.

In some embodiments, the audio receiver 102 includes a power supply port 136. The power supply port 136 may receive a power cord configured to be coupled to a wall outlet. Accordingly, the power supply port 136 may receive an AC voltage via a wall outlet of a house or other application. The power supply port 136 is coupled to the power supply 120 shown in FIG. 2. Alternatively, other types of power supply port 136 can be utilized without departing from the scope of the present disclosure.

In some embodiments, the audio receiver 102 includes an HDMI port 138. The HDMI port 138 can be configured to receive an HDMI cord 112. As described previously, the HDMI port 138 can include eARC functionality to receive audio data from a smart display device 104 or other device with an HDMI cord 112. The HDMI port 138 may be coupled to the eARC module 122 of FIG. 2. Other types of input ports can be utilized to receive audio data or signals from an external device without departing from the scope of the present disclosure.

In some embodiments, the audio receiver 102 includes the channel outputs 114 described in relation to FIG. 1. In particular, the audio receiver 102 includes positive and negative left channel outputs 114L, positive and negative right channel outputs 114R, and positive and negative center channel outputs 114C. As described previously, each of the channel outputs can be connected to a corresponding left, right, or center speaker 106 via a connector 116. The channel outputs 114 can be coupled to the amplifiers 124 described in relation to FIG. 2. Accordingly, the channel outputs 114 provide amplified analog audio signals for each channel from the corresponding amplifier 124.

In some embodiments, the audio receiver 102 includes a subwoofer output 140. The subwoofer output 140 can be utilized to connect a subwoofer speaker to the audio receiver 102. The subwoofer output 140 provides amplified audio signals to the subwoofer speaker.

In some embodiments, the audio receiver 102 includes phono port 142. The phono input port 142 can be utilized to receive analog audio signals from the turntable via the cord that can be plugged into the phono inputs 142. The phono input ports 142 can be coupled to the phono preamplifier 130 described in relation to FIG. 2.

In some embodiments, the audio receiver 102 includes one or more line-in input port 144. The line-in input ports enable the audio receiver 102 to receive analog line level audio signals from an external device. The line-in input ports 144 can be directly coupled to a line-out port of an external device via a connector cord. The lining input port 144 can be coupled to the preamplifier 128 described in relation to FIG. 2, or to other internal components of the audio receiver 102.

In some embodiments, the audio receiver 102 includes a center channel pre-out (CTR-out) 146. The center channel pre-out can be utilized to connect a powered center speaker to the audio receiver 102. The CTR out port 146 can be utilized to provide audio signals to a device external to the audio receiver 102.

In some embodiments, the audio receiver 102 includes one or more pre-out ports 148. The pre-out port 148 may correspond to a port that provides output audio signals that have not yet been amplified. Accordingly, an external amplifier may be coupled to pre-out port 148. The volume of audio provided via the pre-out 148 can be controlled via the smart display device 104 or via direct control of the receiver 102, as described previously.

In some embodiments, the audio receiver 102 can include one or more streamer digital output ports 150. The streamer digital output port 150 can be utilized to connect an external DAC and integrated amplifier to the audio receiver 102.

The audio receiver 102 can include other connectors and other configurations of connectors than those shown in FIG. 3 without departing from the scope of the present disclosure. One or more of the connectors shown in FIG. 3 may not be present in some embodiments. Other connectors not shown in FIG. 3 may be present in some embodiments.

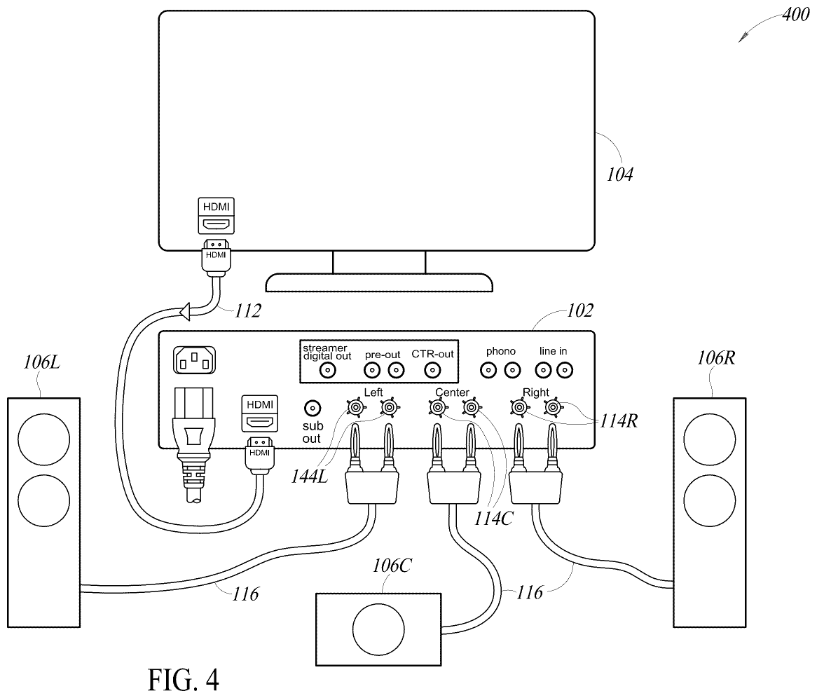

FIG. 4 is an illustration of a system 400 utilizing the audio receiver 102 of FIG. 3, in accordance with some embodiments. The system 400 is one example of a system 100 of FIG. 1. The system 400 includes a smart display device 104 coupled to the audio receiver 102 via a connection 112. The system 400 includes a left channel speaker 106L coupled to the left channel outputs 114L of the audio receiver 102. The system 400 includes a center channel speaker 106C coupled to the center channel outputs 114C of the audio receiver 102. The system 400 includes a right channel speaker 106R coupled to the right channel outputs 114R of the audio receiver 102. The left channel speaker 106L and the right channel speaker 106L correspond to stereo speakers. The system 400 can include other components without departing from the scope of the present disclosure.

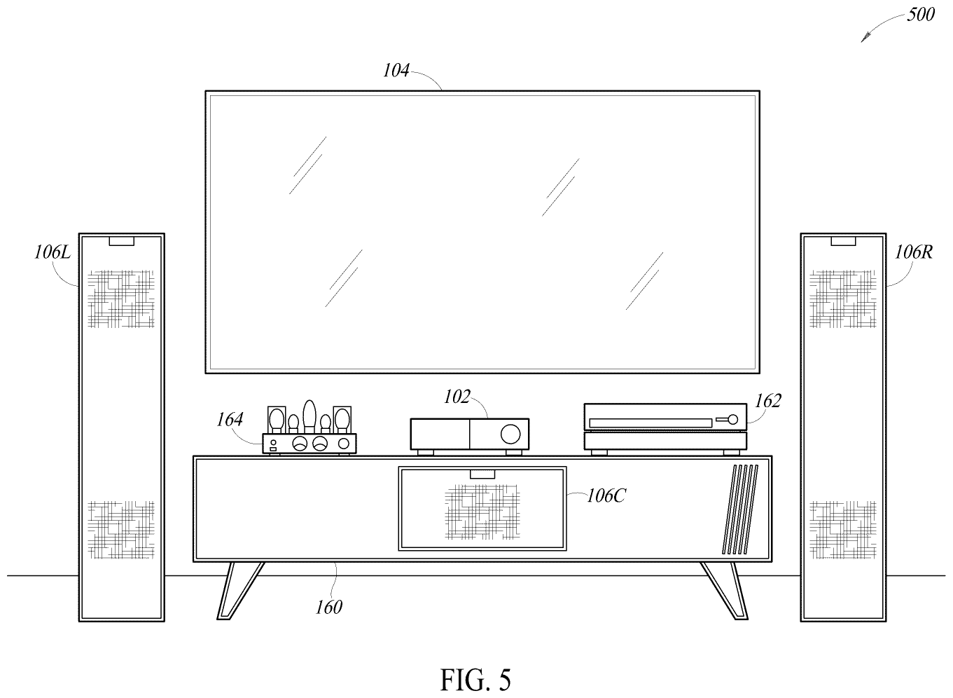

FIG. 5 is an illustration of a system 500 utilizing an audio receiver 102, in accordance with some embodiments. The system 500 is one example of the system 100 of FIG. 1. The audio receiver 102 of FIG. 5 can correspond to the audio receiver 102 described in relation to FIGS. 1-4.

In the system 500, a smart display device 104 is coupled to the audio receiver 102, as described previously. The audio receiver 102 is positioned on a stand 160 below the smart display device 104. A center speaker 106C is positioned in or on the stand 160 in a central orientation with respect to the smart display device 104. The left speaker 106L is positioned on a left side of the stand 160. The right speaker 106R is positioned on the right side of the stand 160. A turntable audio device 162 is positioned on the stand and is coupled to the phono input port of the receiver 102. A standalone amplifier 164 is also positioned on the stand 160 and is coupled to the audio receiver 102 to receive and amplify audio signals from the audio receiver 102.

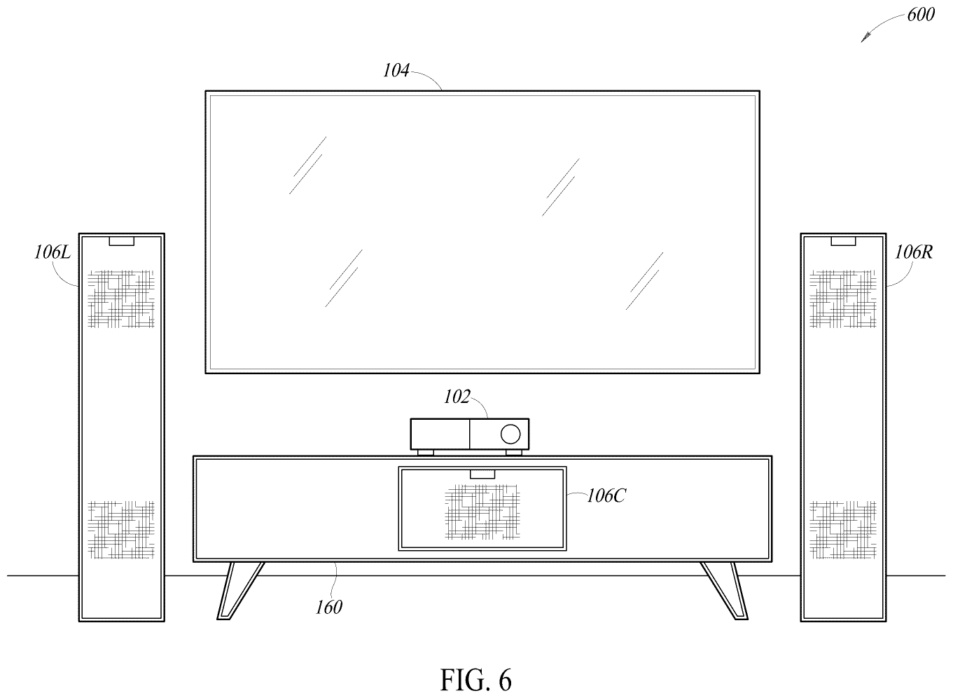

FIG. 6 is an illustration of a system 600 utilizing an audio receiver 102, in accordance with some embodiments. The system 600 is one example of the system 100 of FIG. 1. The audio receiver 102 of FIG. 6 can correspond to the audio receiver 102 described in relation to FIGS. 1-4.

In the system 600, a smart display device 104 is coupled to the audio receiver 102, as described previously. The audio receiver 102 is positioned on a stand 160 below the smart display device 104. A center speaker 106C is positioned in or on the stand 160 in a central orientation with respect to the smart display device 104. The left speaker 106L is positioned on a left side of the stand 160. The right speaker 106R is positioned on the right side of the stand 160.

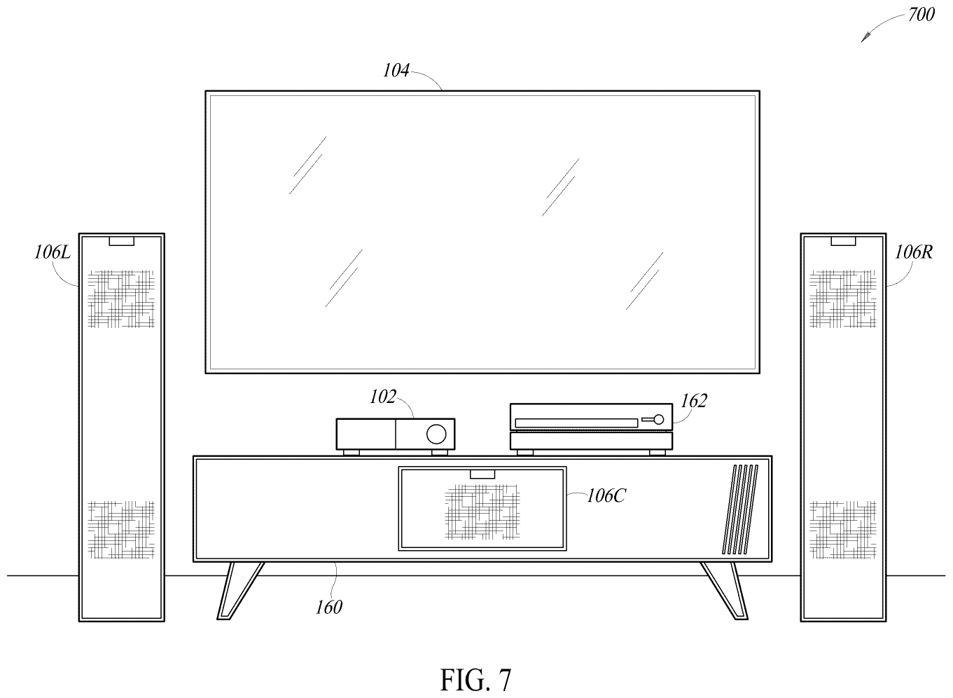

FIG. 7 is an illustration of a system 700 utilizing an audio receiver 102, in accordance with some embodiments. The system 700 is one example of the system 100 of FIG. 1. The audio receiver 102 of FIG. 7 can correspond to the audio receiver 102 described in relation to FIGS. 1-4.

In the system 700, a smart display device 104 is coupled to the audio receiver 102, as described previously. The audio receiver 102 is positioned on a stand 160 below the smart display device 104. A center speaker 106C is positioned in or on the stand 160 in a central orientation with respect to the smart display device 104. The left speaker 106L is positioned on a left side of the stand 160. The right speaker 106R is positioned on the right side of the stand 160. A turntable audio device 162 is positioned on the stand and is coupled to the phono input port of the receiver 102.

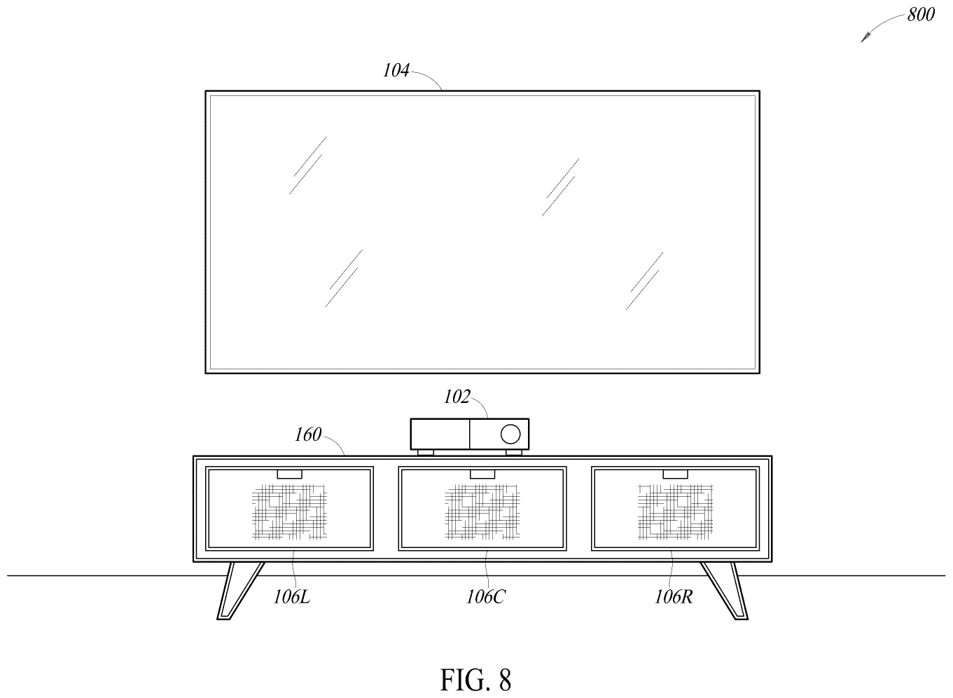

FIG. 8 is an illustration of a system 800 utilizing an audio receiver 102, in accordance with some embodiments. The system 800 is one example of the system 100 of FIG. 1. The audio receiver 102 of FIG. 8 can correspond to the audio receiver 102 described in relation to FIGS. 1-4.

In the system 800, a smart display device 104 is coupled to the audio receiver 102, as described previously. The audio receiver 102 is positioned on a stand 160 below the smart display device 104. The left speaker 106L, the right speaker 106R, and the center speaker 106C are positioned in or on the stand 160.

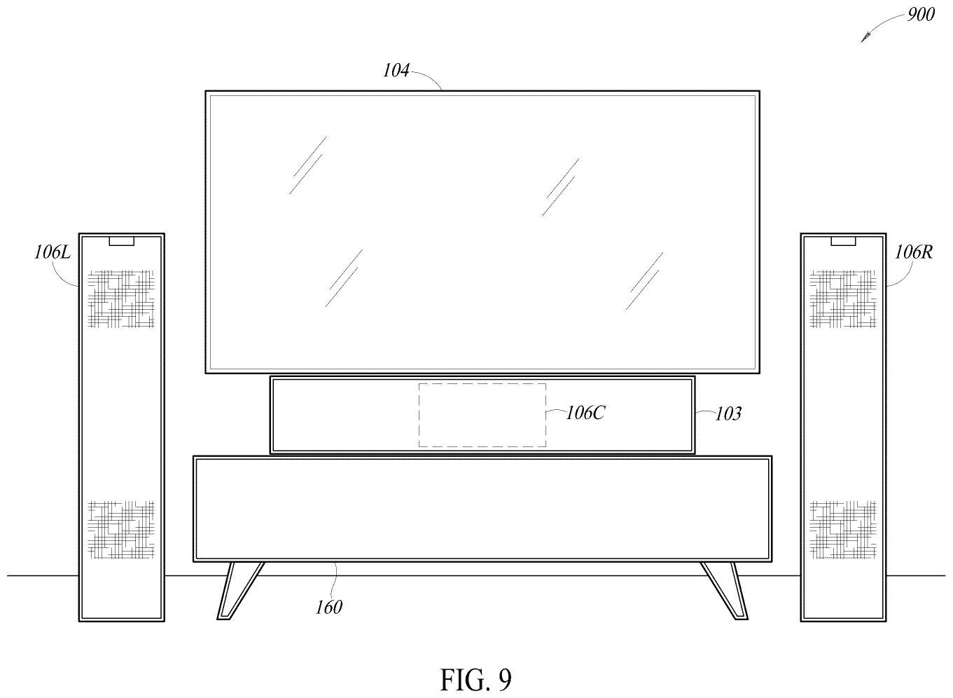

FIG. 9 is an illustration of a system 900, including an audio receiver 103, in accordance with some embodiments. The audio receiver 103 of FIG. 9 is similar in many regards to the audio receiver 102 of FIGS. 1-8.

The audio receiver 103 is coupled to the smart display device 104 in a similar manner as the audio receiver 102, as described previously. In particular, the audio receiver 103 can receive audio signals from the smart display device 104 via a connection 112, such as an HDMI cord including eARC functionality.

The audio receiver 103 includes a center speaker 106C. The center speaker 106C is built into the audio receiver 103. In some terminologies, it may be said that the audio receiver 103 is built into the center speaker. The audio receiver 103 provides center channel to the center channel speaker 106C. The center channel speaker 106C outputs center channel sound. Although the center channel speaker 106C is shown as a single speaker, in practice, the center channel speaker 106C can include multiple audio transducers such as one or more woofers and one or more tweeters. As will be set forth in more detail below, in some embodiments the center speaker 106C includes a single full range driver, to the exclusion of any other drivers or transducers. The system 900 includes a left speaker 106L and a right speaker 106R. In some embodiments, the left speaker 106L and the right speaker 106R are not coupled to the audio receiver 103 by a wired connection. Instead, the audio receiver 103 is coupled to the left speaker 106L and the right speaker 106R by wireless connection, such as Bluetooth, Wi-Fi, or another type of wireless connection. The audio receiver 103 provides left channel audio data wirelessly to the left speaker 106L. The audio receiver 103 provides right channel audio data wirelessly to the right speaker 106R.

The audio receiver 103 can include many of the same ports and internal components as described in relation to the audio receiver 102 in FIGS. 2 and 3. However, the audio receiver 103 may not include left, right, and center channel output ports 114. This is because the audio receiver 103 includes a built-in center channel speaker 106C. Furthermore, the audio receiver 103 includes only a single channel amplifier 124 for the center channel connected to the center speaker 106C. The audio receiver 103 can include one or more wireless communication modules to wirelessly provide the left channel audio data and the right channel audio data to the left and right speakers 106L/R.

In some embodiments, the audio receiver 103 may be described as a speaker-audio receiver 103 because the audio receiver includes a built-in speaker for the center channel. The audio receiver 103 may also be termed an active or powered speaker. The audio receiver 103 processes three audio channels as described in relation to the audio receiver 102. The audio receiver 103 includes one or more eARC/HDMI inputs as described in relation to the audio receiver 102. The audio receiver 103 can include L and R audio channel pre-out RCA jacks for connecting to the bypass input on an integrated amplifier or to the inputs on powered left and right stereo speakers. In some embodiments, the audio receiver 103 may include two additional amplifiers to power left and right stereo speakers via speaker wire.

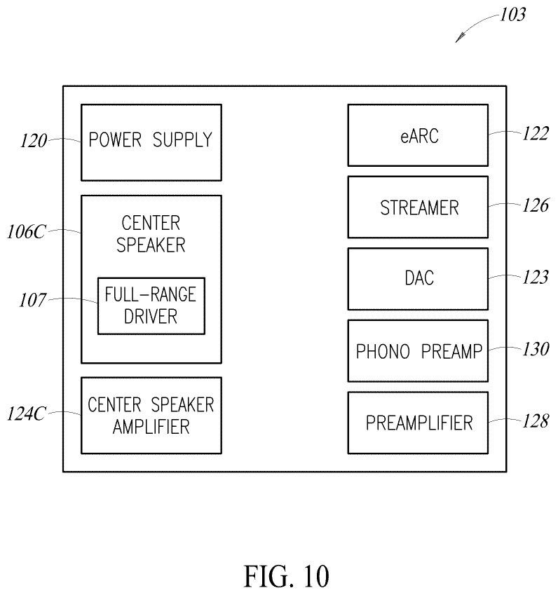

FIG. 10 is a block diagram of internal components of an audio receiver 103, in accordance with some embodiments. The audio receiver 103 of FIG. 10 is one example of an audio receiver 103 of FIG. 9.

The audio receiver 103 includes many components in common with the audio receiver 102 as described in relation to FIG. 2. For example, the audio receiver 103 includes a power supply 120, and eARC module 122, a DAC 123, a streamer 126, a preamplifier 128, and a phono preamp 130. These components may be substantially the same as described in relation to FIG. 2. In some cases, these components may be somewhat different than described in relation to FIG. 2 in order to accommodate the different structure and functionality of the audio receiver 103.

In some embodiments, the audio receiver 103 includes a center speaker amplifier 124C and the internal center speaker 106C. The center speaker amplifier 124C provides amplified audio signals to the center speaker 106C. In some embodiments, the audio receiver 103 includes only a single channel amplifier for the center speaker 106C. In alternative embodiments, the audio receiver 103 may include two additional amplifiers to power left and right channel stereo speakers via speaker wire. The audio receiver 103 can include different components or variations on the components described herein without departing from the scope of the present disclosure.

In some embodiments, the center speaker 106C includes a full range driver 107. The full range driver 107 is a speaker that outputs audio across the entire range of human hearing. Typically, humans are able to hear sounds with frequencies 20 Hz and 20,000 kHz. In some embodiments, the full range driver 107 outputs sound with a frequency range between 40 Hz and 20,000 kHz. In some embodiments, the full range speaker 107 outputs audio in a range of frequencies that is somewhat less than the entire range of human hearing. Accordingly, as used herein, a full range driver can include a driver that outputs a range of frequencies having an upper limit that is between 80% and 100% of the range of human hearing. For example, in some embodiments, the full range driver 107 outputs audio in a range of frequencies between 120 Hz and 16,000 Hz.

Utilizing the full range driver 107 for central channel audio provides several benefits over other possible solutions. For example, one possible solution is to utilize a woofer and a tweeter for center channel audio. A woofer outputs audio between 40 Hz and 1000 Hz. A tweeter typically outputs sound between 1000 Hz and 20,000 Hz. While the combination of a woofer and a tweeter seems to cover the entire range of human hearing, there are drawbacks. Dialogue audio typically centers around a frequency of 1000 Hz. This corresponds to the upper range of a woofer and the lower range of a tweeter. The woofer may not output high-quality audio near the upper extreme of its range. The tweeter may not output high-quality audio at the lower extreme its range. Furthermore, the audio quality can suffer from crossover point interference. The upper range of the woofer and the lower range of the tweeter typically will overlap to some extent. This overlapping band can be termed a crossover point or a crossover range. The audio output from the tweeter and the audio output from the woofer in the crossover range can interfere with each other in a manner that decreases overall audio quality.

In contrast to the combination of a woofer and a tweeter, the full range driver 107 outputs high-quality audio in the range of 1000 Hz. Accordingly, the full range driver 107 outputs high-quality dialogue audio. Furthermore, in some embodiments, utilizing a full range driver results in simplified circuitry. For example, a full range driver 107 can be utilized without a complex crossover network that receives the full range of audio and then provides low frequencies to the woofer and high frequencies to the tweeter.

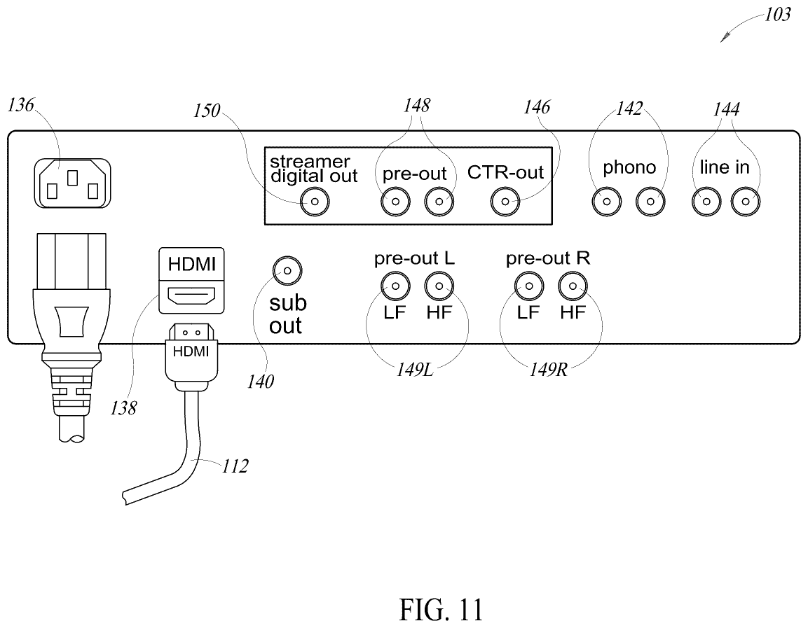

FIG. 11 is an illustration of an external face of an audio receiver 103, in accordance with some embodiments. The audio receiver 103 of FIG. 11 is one example of an audio receiver 103 as described in relation to FIGS. 9 and 10.

The audio receiver 103 includes many components in common with the audio receiver 102 as described in relation to FIG. 3. For example, the audio receiver 103 includes the power inputs 136, the HDMI input 138, the phono ports 142, the line-in port 144, the CTR-out port 146, the pre-outs 148, and the digital streamer port 150.

In some embodiments, the audio receiver 103 includes a left pre-out port 149L to provide audio signals to an external left channel speaker. The audio receiver 103 includes a right pre-out port 149R to provide audio signals to an external right channel speaker. The left and right pre-out ports provide audio having selected characteristics to left and right power speakers, or to amplifiers coupled to left and right speakers. The audio receiver 103 can include other ports without departing from the scope of the present disclosure.

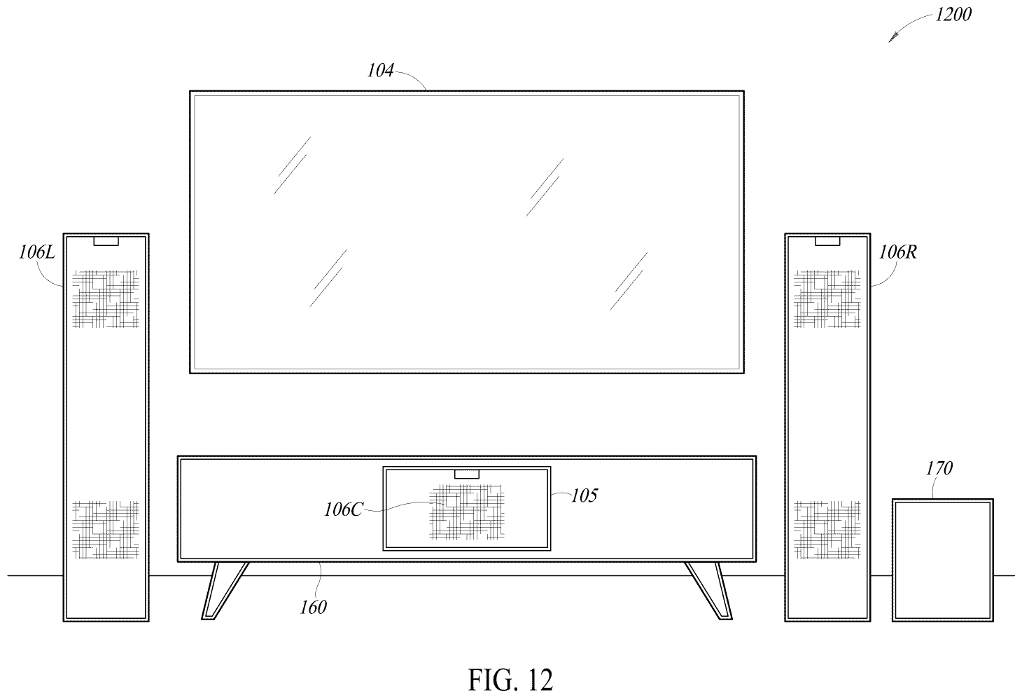

FIG. 12 is an illustration of a system 1200, utilizing an audio receiver 105, in accordance with some embodiments. The audio receiver 105 of FIG. 12 is similar in many regards to the audio receivers 102 and 103 of FIGS. 1-11.

The audio receiver 105 is coupled to a smart display device 104 in a similar manner as the audio receivers 102 and 103, as described previously. In particular, the audio receiver 105 can receive audio signals from the smart display device 104 via a connection 112, such as an HDMI cord including eARC functionality.

The audio receiver 105 includes a built-in center speaker 106C. The audio receiver 105 provides center channel audio to the center channel speaker 106C. The center channel speaker 106C outputs center channel audio. Although the center channel speaker 106C is shown as a single speaker, in practice, the center channel speaker 106C can include multiple audio transducers such as one or more woofers and one or more tweeters, all driven with the center channel.

The system 1200 includes a left speaker 106L and a right speaker 106R that are separate from the audio receiver 105. The left and right speakers 106L and 106R can received amplified audio signals or pre-out audio signals via wired connections to the audio receiver 105. In some embodiments, the left speaker 106L and the right speaker 106R are not coupled to the audio receiver 105 by a wired connection. Instead, the audio receiver 105 is coupled to the left speaker 106L and the right speaker 106R by wireless connection, such as Bluetooth, Wi-Fi, or another type of wireless connection. The audio receiver 105 provides left channel audio data wirelessly to the left speaker 106L. The audio receiver 105 provides right channel audio data wirelessly to the right speaker 106R.

The audio receiver 105 can include many of the same ports and internal components as described in relation to the audio receiver 102 in FIGS. 1-11.

In some embodiments, the audio receiver 105 accepts 3.0 or 3.1 channel audio input via HDMI. In some embodiments, the audio receiver 105 includes A 3.1 channel HDMI audio extractor or an integrated circuit (IC) designed for HDMI audio processing. The extractor can separate the audio from the HDMI signal and can output a digital audio stream. The HDMI signal can also carry control signals (e.g., CEC for consumer electronics control), which will allow bi-lateral volume control between devices.

In some embodiments, the audio receiver 105 accepts 2.0 channel (stereo) audio via Bluetooth or another wireless protocol. In this case, the other receiver 105 includes a Bluetooth module or other type of wireless module to facilitate Bluetooth/wireless communication. In some embodiments, the audio receiver 105 can output left and right channel audio to left and right speakers 106L/R via Bluetooth or via another wireless protocol. The Bluetooth/wireless model can support an advanced audio distribution profile (A2DP) protocol for streaming stereo audio. The module can receive digital audio from the Bluetooth/wireless source and can then pass it as digital audio. Alternatively, or additionally, the module can convert the digital audio to analog audio internally.

In some embodiments, the audio receiver 105 includes one or more manual buttons, switches, dials, or other types of manual inputs. A user of the audio receiver 105 can manually switch the audio receiver 105 between HDMI and Bluetooth/wireless audio modes. If the user desires the audio receiver 105 to play audio received via HDMI, the user can manually select to play audio received via HDMI. If the user desires the audio receiver 105 to play audio received via Bluetooth/wireless, the user can manually select to play audio received via Bluetooth or another wireless protocol. In some embodiments, the audio receiver can receive wireless commands via Wi-Fi, Bluetooth, or other wireless communication from a remote control or smart phone. The audio receiver 105 can play audio from the source indicated in the wireless commands.

In some embodiments, the audio receiver 105 automatically detects whether audio should be played from HDMI or Bluetooth/wireless. In this case, the other receiver 15 can include one or more processors, such as a microcontroller, that detects which input is active and switches between the sources accordingly. Various automatic source detection/selection methods can be utilized without departing from the scope of the present disclosure.

In some embodiments, the audio receiver 105 includes a DAC. The DAC can correspond to a 3.1 channel DAC to convert digital audio signals to analog audio signals if an amplifier (described below) and the rest of the audio path are analog.

In some embodiments, the audio receiver 105 includes a preamplifier. The preamplifier can correspond to a 3.1 channel pre-amplifier stage that conditions the audio signal and adjusts the level before sending the audio signal to the 3.0 channel power amplifier. The preamplifier can also include tone controls (bass, treble) or a digital signal processor (DSP) for more sophisticated audio processing and equalization.

In some embodiments, the audio receiver 105 includes a power amplifier. The power amplifier can include a three-channel power amplifier that boosts the conditioned audio signal to a level that can drive the speakers. Class A, class AB, class D, or other types of amplifiers. The three-channel amplifier includes a center channel amplifier that amplifies the center channel audio and provides the amplified center channel audio to the center speaker 106C. The three-channel amplifier includes a left channel amplifier that amplifies the left channel audio and provides the left channel audio to a left channel output port. The three-channel amplifier includes a right channel amplifier that amplifies the right channel audio and provides the right channel audio to a right channel audio output port. Left and right speakers can receive the amplified left and right channel audio via a wired connection to the left and right output ports. In the case of 3.1 channel audio, the audio receiver 105 includes a subwoofer output port. A subwoofer can be connected via a wired connection to the subwoofer output port.

In some embodiments, the audio receiver 105 includes a power supply. The power supply provides power to the various components of the audio receiver 105. The power supply 105 can provide different voltages to different components. The power supply can include a combination of transformers, regulators, and filters to provide stable DC voltages.

In some embodiments, the audio receiver 105 includes a control interface. The control interface can include physical buttons or knobs for volume control, input selection, Bluetooth/wireless pairing, or for control of other features. In some embodiments, a processor, such as a microcontroller, can manage these functions, offering more complex control schemes, like remote control or even an app-based interface.

In some embodiments, the audio receiver 105 includes protection circuitry. The protection circuitry can include circuits to protect against overvoltage, undervoltage, overcurrent, and thermal overload. This is crucial for safety and longevity.

In some embodiments, the audio receiver 105 includes an enclosure that houses the speaker and the other components. The enclosure can also include heat management components such as heat sinks or other components.

In some embodiments, the audio receiver 105 including the center speaker 106C can be used in a 1.0 or 1.1 setup. In this case, the audio receiver 105 may sum the three or more constituent audio channels carried by the HDMI AV signal to a single channel used to drive the single speaker 106C and may optionally output a subwoofer signal via RCA. In some embodiments, the audio receiver 105 may be hooked up to a TV HDMI output and used immediately without further setup.

The audio receiver 105 can include left and right audio channel pre-out RCA jacks for connecting to a bypass input on an integrated amplifier or to inputs on powered left and right stereo speakers. As described previously, in some embodiments, the audio receiver 103 may include two additional amplifiers to power left and right stereo speakers via speaker wire.

In some embodiments, the audio receiver 105 can be utilized in conjunction with various external components. For example, in some embodiments a user of the audio receiver 105 may couple an external three-channel DAC, an external three-channel amplifier, an external streamer, or other external components to the audio receiver 105. Users may utilize other external components in conjunction with the audio receiver 105. These external components may be selectively used as an alternative to corresponding internal components included in the audio receiver 105. Alternatively, such external components may be utilized in embodiments in which the audio receiver 105 does not include corresponding internal components.

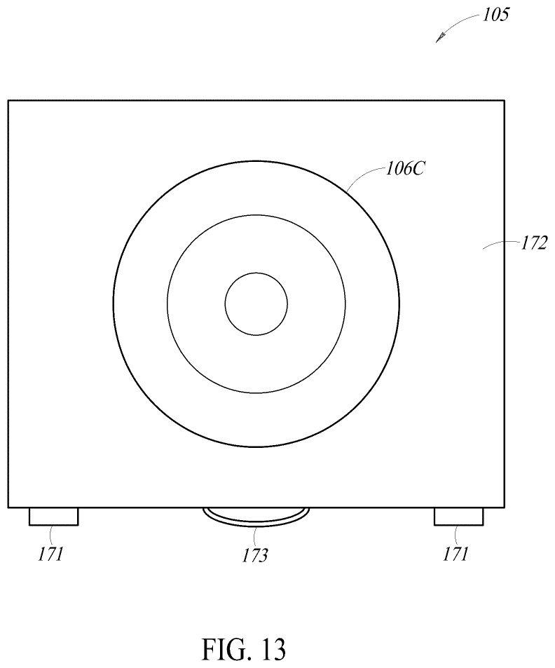

FIG. 13 is an illustration of a front face 172 of an audio receiver 105, in accordance with some embodiments. The audio receiver 105 includes the built-in center speaker 106C as described in relation to FIG. 12.

In some embodiments, the audio receiver 105 of FIG. 13 can have a height dimension between 6 inches and 10 inches, a width dimension between 12 inches and 16 inches, and a depth dimension between 8 inches and 12 inches. Other dimensions can be utilized without departing from the scope of the present disclosure.

In some embodiments, the audio receiver 105 includes sliders 171 on a bottom surface of the audio receiver 105. The sliders can include felt or another material that is soft and enables easy movement of the audio receiver 105 across the top surface of a shelf or other structure on which the audio receiver 105 rests. The audio receiver 105 can include feet or other components coupled to a bottom of the audio receiver 105.

In some embodiments, the audio receiver 105 includes one or more handles 173. The one or more handles can enable a user to conveniently slide, in conjunction with the sliders 171, the audio receiver 105 back and forth on the shelf or surface on which the audio receiver 105 rests. In some embodiments, the handle 173 can include a simple ring through which a user can place a finger to move the audio receiver 105.

During use of the audio receiver 105, it may be beneficial that the front face 172 extend beyond the edge or front plane of the shelf or surface on which the audio receiver 105 rests. This can help ensure a high-quality audio experience for users of the audio receiver 105. When the audio receiver 105 is not in use, it may be beneficial to adjust a position of the audio receiver 105 so that the front face 172 does not extend beyond the edge or front plane of the shelf or surface on which the audio receiver 105 rests, or is recessed below. This can help ensure that individuals do not bump the audio receiver 105 when the audio receiver 105 is not in use. The sliders 171 and the handle 173 facilitate convenient movement of the audio receiver 105. The handle 173 can be placed on other surfaces or can have other configurations without departing from the scope of the present disclosure.

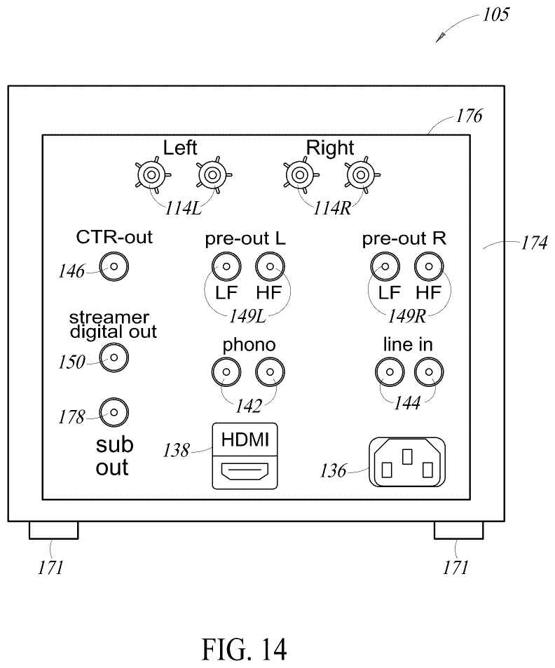

FIG. 14 is an illustration of a back face 174 of the audio receiver 105 of FIG. 13, in accordance with some embodiments. The back face 174 includes a panel 176. A plurality of input and output ports or connectors are coupled to the back face 174.

The audio receiver 105 includes many components in common with the audio receivers 102 and 103 as described in relation to FIGS. 3 and 11. For example, the audio receiver 103 includes the power input 136, the HDMI input 138, the phono ports 142, the line-in ports 144, the CTR-out port 146, the pre-outs 148, the pre-outs 149L/R, and the digital streamer port 150. The audio receiver 105 also includes a subwoofer output port 178. The audio receiver 105 can include other ports without departing from the scope of the present disclosure.

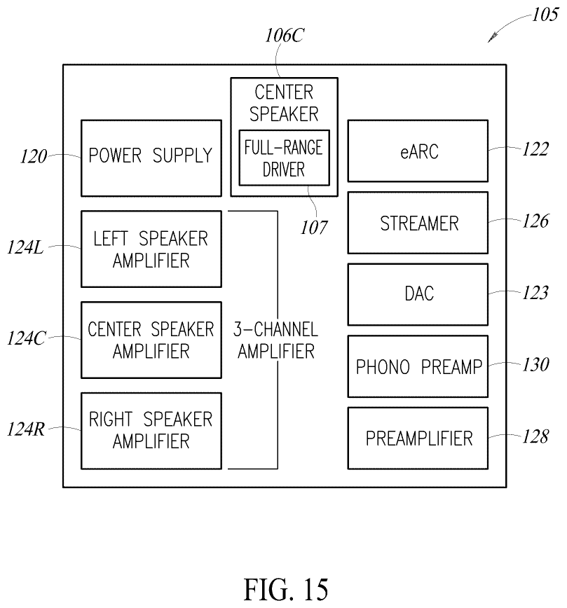

FIG. 15 is a block diagram of internal components of an audio receiver 103, in accordance with some embodiments. The audio receiver 105 of FIG. 15 is one example of an audio receiver 105 of FIGS. 12-14.

The audio receiver 105 includes many components in common with the audio receiver 102 and 103 as described in relation to FIGS. 2 and 10. The audio receiver 103 includes a built in central speaker 106C, a power supply 120, an eARC module 122, a DAC 123, a three-channel amplifier including left speaker, right speaker, and center speaker amplifiers 124L/R/C, a streamer 126, a preamplifier 128, and a phono preamp 130. These components may be substantially the same as described in relation to FIGS. 2 and 10. In some cases, these components may be somewhat different than described in relation to FIGS. 2 and 10 in order to accommodate the different structure and functionality of the audio receiver 105.

In some embodiments, the center speaker 106C includes a single full range driver 107. Accordingly, the center speaker 106C including the full range driver 107 outputs high-quality dialogue audio.

In some embodiments, the audio receiver 105 includes an extractor, a Bluetooth/wireless module, one or more processors, and other components. The audio receiver 105 can include different components or variations on the components described herein without departing from the scope of the present disclosure.

In some embodiments, an audio receiver kit can enable users to build custom audio receivers. The audio receiver kit can include components configured to be mounted to an audio receiver housing in order to build or assemble an audio receiver such as an audio receiver 102, 103, or 105.

An audio receiver kit can include a back panel configured to be mounted to the audio receiver housing, such as a housing for an audio receiver 102, 103, or 105. The back panel can include ports such as those described in relation to FIGS. 3, 11, and 14. The back panel can include an HDMI port, a power connector port, left channel, a right channel, and center channel amplified output ports, pre-out ports, line level ports, streamer port, phono ports, subwoofer ports, optical ports, or other types of ports for an audio receiver 102, 103, or 105. The back panel can include internal electronic components for an audio receiver such as a power supply, single channel or multi-channel amplifiers, a DAC, an extractor, a streamer, a preamplifier, a phono preamplifier, or other components such as those described in relation to FIGS. 2, 10, and 15. The back panel can include mounting mechanisms, such as screw holes, by which the back panel can be mounted to a custom housing. When the back panel is mounted to the custom housing, the various input and output ports are exposed, while the internal electrical components are positioned within the housing.

In some embodiments, an audio receiver kit can include a control panel. The control panel can be configured to be mounted to a top or side surfaces of the housing. The control panel can include buttons, switches, dials, or other manual inputs to control power, Bluetooth/wireless communication, input switching, volume control, or other aspects of an audio receiver. The control panel can include mounting mechanisms that enable the control panel to be fastened to the housing.

In some embodiments, an audio receiver kit can include a front panel. The front panel can include one or more LEDs or other types of indicators that indicate which input is currently selected, when audio decoding is occurring, volume adjustments, or other aspects associated with an audio receiver. The front panel can also include one or more receivers configured to receive remote control signals, such as from an infrared or radiofrequency remote control. The front panel can include mounting mechanisms that enable the front panel to be mounted into the housing.

In some embodiments, an audio receiver kit can include a remote control. The remote control can include an infrared remote control, a radiofrequency remote control, or other types of remote controls. The remote control can enable a user to remotely control aspects of the audio receiver such as powered on or off, changing the volume, changing inputs selection, enabling wireless audio, or other aspects associated with an audio receiver.

In some embodiments, the kit can include a central speaker. The central speaker can be configured to be mounted in the housing as a built-in central speaker, such as in an audio receiver 103 or 105.

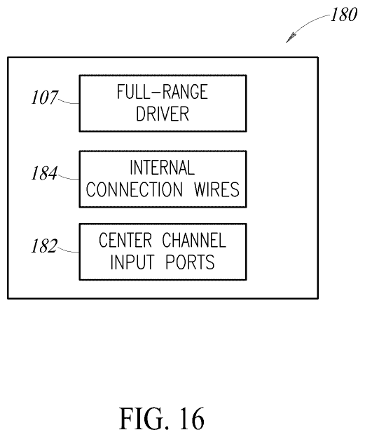

FIG. 16 is a block diagram of a passive center channel speaker box 180, in accordance with some embodiments. The passive center channel speaker box 180 includes a full ranger driver 107, center channel input ports 182, and internal connection wires 184.

In some embodiments, the passive center channel speaker box 180 differs from other audio receivers in that the passive center channel speaker box 180 does not receive electricity. The components of the passive center channel speaker box 180 are entirely passive. The center channel speaker box 180 receives amplified center channel audio at the center channel input ports 182. Accordingly, a separate audio receiver (not pictured) receives the audio signal (e.g., eARC), extracts the center channel audio, amplifies the center channel audio, and outputs the amplified center channel audio to the passive center channel speaker box 180. Connecting wires (not shown), are coupled between the audio receiver and the center channel input ports 182 of the passive speaker box 180.

The amplified center channel audio signal is carried from the center channel input ports 182 to the full range driver 107 by internal connection wires 184. The full range driver 107 outputs center channel audio in accordance with the amplified center channel audio signal. As described previously, use of the full range driver 107 provides several benefits. Most notably, use of the full range driver 107 results in high quality dialogue audio on the center channel.

The passive center channel speaker box 180 is a simple, cost-effective solution to provide high-quality center channel audio. As the center channel speaker box 180 only includes a single full range driver 107 and connection wires 184 within the center channel speaker box 180, the center channel speaker box 180 is simple to manufacture and relatively inexpensive. The passive center channel speaker box 180 can be positioned in an entertainment system similarly as the central speaker 106C of FIGS. 1 and 4-8.

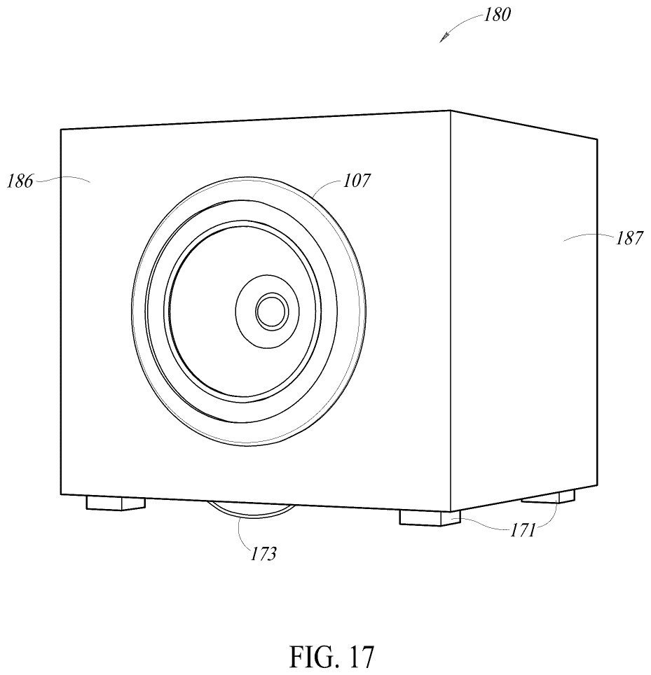

FIG. 17 is an illustration of a passive center channel speaker box 180, in accordance with some embodiments. The passive center channel speaker box 180 of FIG. 17 is one example of a passive center channel speaker box 180 of FIG. 16.

The passive center channel speaker box 180 includes a front face (or front panel) 186. The full range driver 107 is mounted in the front face 186. The passive center channel speaker box 118 includes lateral faces 187. The top face, the bottom face, and the back face are not apparent in FIG. 17.

In some embodiments, the passive center channel speaker box 180 includes one or more handles 173. The one or more handles can enable a user to conveniently slide the center channel speaker box 180 back and forth in conjunction with sliders 171.

During use of the passive center channel speaker box 180, it may be beneficial that the front face 186 extend beyond the edge or front plane of the shelf or surface on which the audio receiver 105 rests. This can help ensure a high-quality audio experience for users of the passive center channel speaker box 180. When the passive center channel speaker box 180 is not in use, it may be beneficial to adjust a position of the passive center channel speaker box 180 so that the front face 186 does not extend beyond the edge or front plane of the shelf or surface on which the audio receiver 105 rests, or is recessed below. This can help ensure that individuals do not bump the audio receiver 105 when the passive center channel speaker box 180 is not in use. The sliders 171 and the handle 173 facilitate convenient movement of the audio receiver 105. The handle 173 can be placed on other surfaces or can have other configurations without departing from the scope of the present disclosure.

In some embodiments, the center channel speaker box 180 has a width between 10 inches and 15 inches. In some embodiments, the center channel speaker box 180 has a height between 8 inches and 12 inches. In some embodiments, the center channel speaker box 180 is a depth between 8 inches and 12 inches. In some embodiments, the full range driver 107 has a diameter between 4 inches and 8 inches. Other dimensions can be utilized without departing from the scope of the present disclosure.

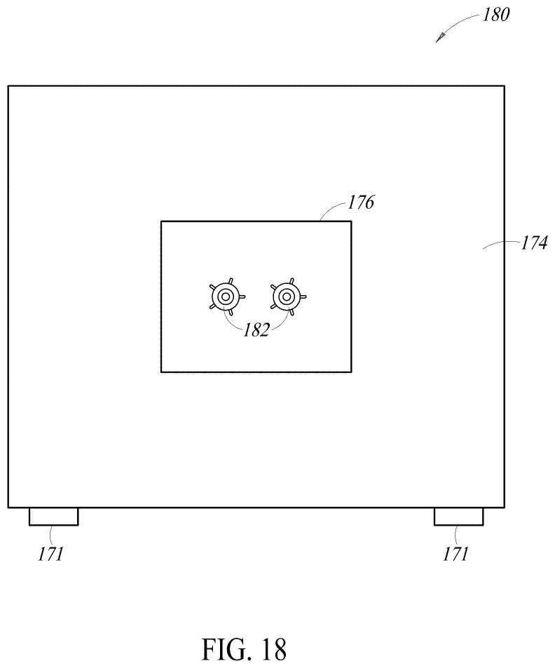

FIG. 18 is an illustration of the back face 176 of the passive center channel speaker box 180 of FIG. 17, in accordance with some embodiments. The back face 174 includes a panel 176. The center channel input ports 182 are mounted in the panel 176. In some embodiments, the two center channel input ports are the only input/output ports on the panel 176.

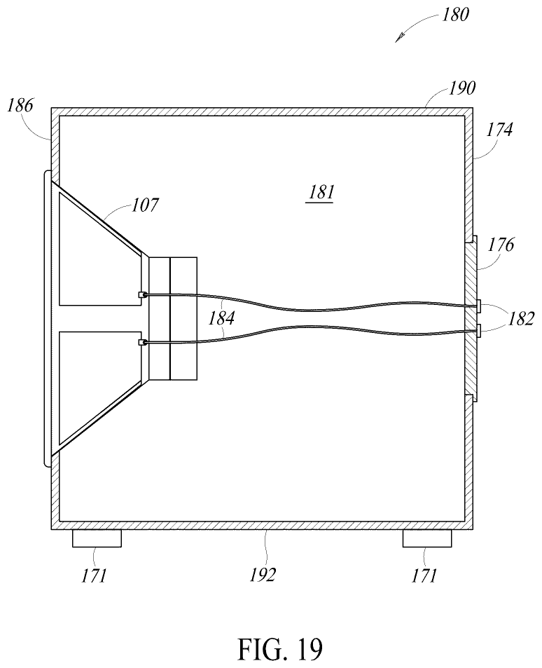

FIG. 19 is a cross-sectional view of the passive center channel speaker box 180 of FIG. 17, in accordance with some embodiments. The center channel input ports 18 are shown as being stacked vertically in FIG. 19, though, in practice, the center channel input ports 182 may be positioned side-by-side in a lateral manner, as shown in FIG. 18.

The full range driver 107 is mounted in the front face 186. Internal connection wires 184 extend between the center channel input ports 182 and the full range driver 107. The internal connection wires 184 carries the amplified center channel audio to the full range driver 107.

As can be seen in FIG. 19, the interior of the passive center channel speaker box 180 is simple and uncluttered. There is no complex electronic circuitry, as the passive center channel speaker box 180 does not receive power, in accordance with some embodiments.

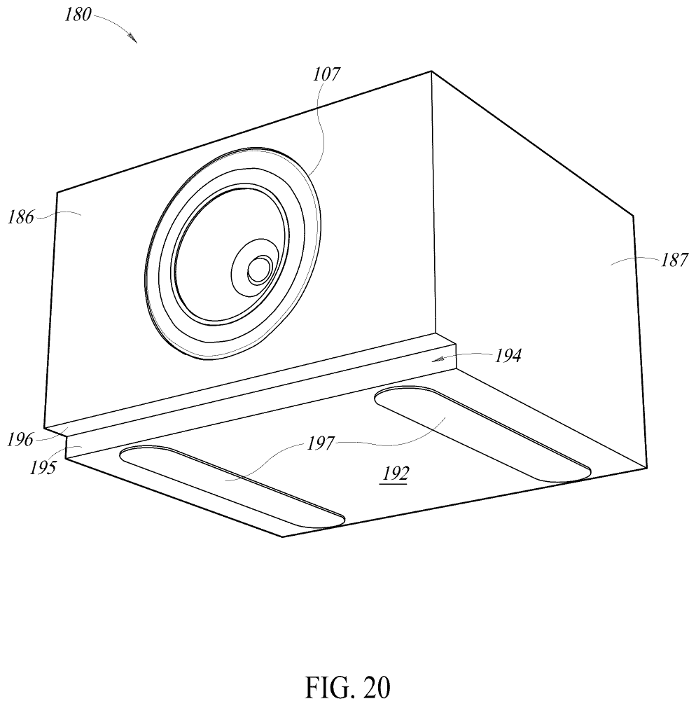

FIG. 20 is a perspective view of a passive center channel speaker box 180, in accordance with some embodiments. The passive center channel speaker box 180 of FIG. 20 is one example of a passive center channel speaker box 180 of FIG. 16.

The center channel speaker box 180 of FIG. 20, differs from the center channel speaker box 180 of FIG. 17 in a few regards. For example, thin sliders 197 are mounted on the bottom face 192 of the center channel speaker box 180. In some embodiments, the sliders 197 are felt. The sliders 197 enable the passive center channel speaker box 180 to slide back and forth easily. Though not shown in FIG. 20, in some embodiments, the passive center channel speaker box 180 can include a handle a groove, or other structure to facilitate moving the passive center channel speaker box 180 back and forth.

The passive center channel speaker box 180 of FIG. 20 also includes an overhang structure 194, in accordance with some embodiments. The overhang structure 194 includes a face 195 that is recessed with respect to the front face 186. The overhang structure 194 includes an overhang face 196 facing downward.

The back face and the interior of the passive center channel speaker box 180 of FIG. 20 can be substantially the same as the passive center channel speaker box 180 of FIGS. 18 and 19.

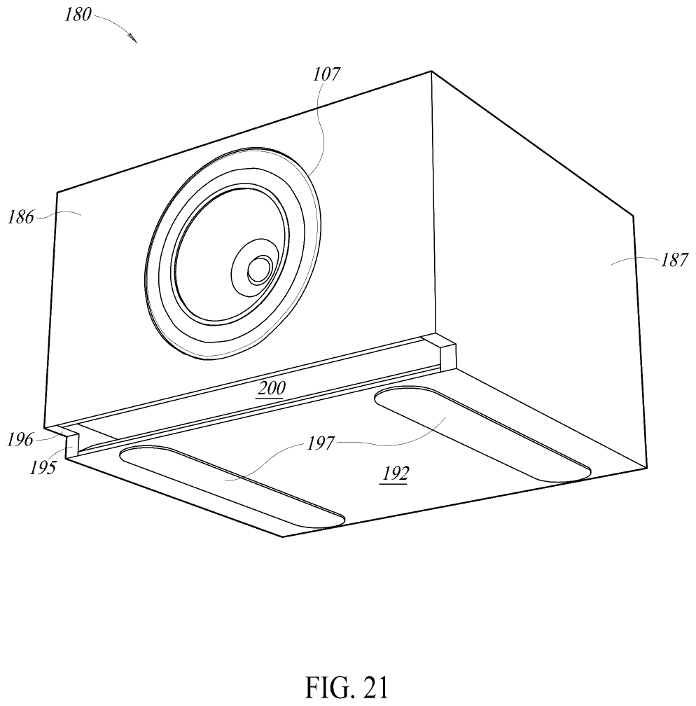

FIG. 21 is a perspective view of a passive center channel speaker box 180, in accordance with some embodiments. The passive center channel speaker box 180 of FIG. 21 is one example of a passive center channel speaker box 180 of FIG. 16.

The passive center channels speaker box 180 of FIG. 21 is substantially similar to the passive center channel speaker box 180 of FIG. 20, except that a low-frequency port 200 is positioned at the overhang structure 194. The low-frequency port 200 includes an opening to the interior of the passive center channel speaker box 180. During operation of the full range driver 107, the motion of the diaphragm of the full range driver 107 results in the compression and expansion of air within the center channel speaker box 180. The compression and expansion can drive low frequency sound waves out of the port 200. This can result in an enhanced audio experience for users.

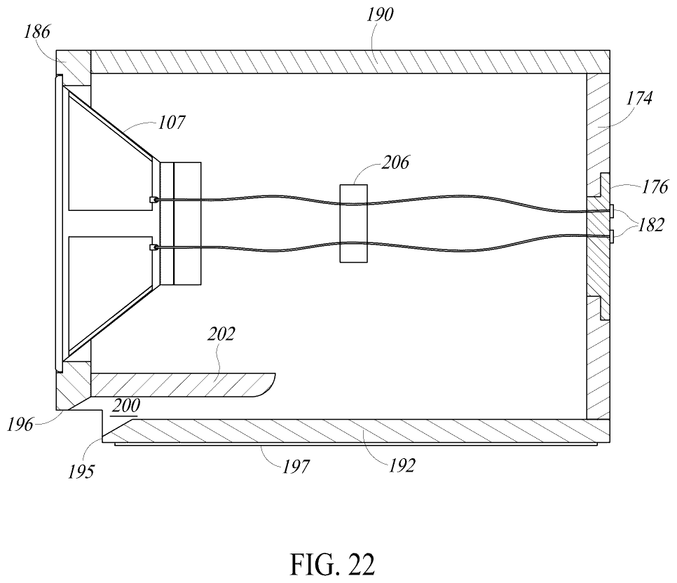

FIG. 22 is a cross-sectional view of the passive center channel speaker box 180 of FIG. 21, in accordance with some embodiments. The view of FIG. 22 illustrates an overhang 202 positioned above the low-frequency port 200. The overhang 202 participates in the driving of low-frequency sound from the interior of the passive center channel speaker box 180. The overhang can have a depth between 2 inches and 4 inches, though other dimensions can be utilized without departing from the scope of the present disclosure.

FIG. 22 also illustrates a crossover network 206 positioned in the interior of the passive center channel speaker box 180, in accordance with some embodiments. The crossover network can correspond to a passive filter including one or more inductors and/or one or more capacitors to filter out selected ranges of soundwaves. In some embodiments, the crossover network 206 is not present.

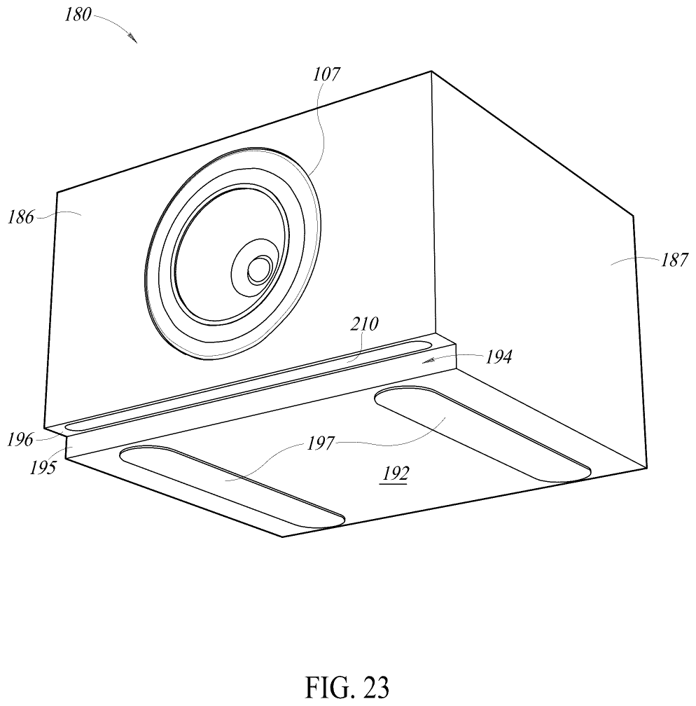

FIG. 23 is a perspective view of a passive center channel speaker box 180, in accordance with some embodiments. The passive center channel speaker box 180 of FIG. 23 is one example of a passive center channel speaker box 180 of FIG. 16.

The passive center channels speaker box 180 of FIG. 23 is substantially similar to the passive center channel speaker box 180 of FIG. 20, except that a finger groove 210 is positioned in the downward facing surface 196 of the overhang region 194. The finger groove 210 is configured to enable user to position a finger in the groove 210, to adjust the position of the center channel speaker box 180.

In some embodiments, the audio receiver 103 of FIG. 9 has the same shape as any of the passive center channel speaker boxes 180 of FIGS. 17-23. The audio receiver 103 of FIG. 9 is different from the passive speaker boxes 180 due to the presence of the additional internal components and additional back face connectors.

In some embodiments, the audio receiver 105 of FIG. 12 has the same shape as any of the passive center channel speaker boxes 180 of FIGS. 17-23. The audio receiver 105 of FIG. 12 is different from the passive speaker boxes 180 due to the presence of the additional internal components and additional back face connectors.

In some embodiments, the center speakers 106C of FIGS. 1 and 4-8 have the same shape as any of the passive center channel speaker boxes of FIGS. 17-23, though there may be differences in internal components and back face ports. The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An audio device, comprising:
an audio input module configured to receive center channel audio data from a smart display device;
a center channel speaker; and
a single-channel amplifier coupled between the audio input module and the center channel speaker.

2. The audio device of claim 1, wherein the center channel speaker comprises a full-range driver.

3. The audio device of claim 2, wherein the full range driver is configured to output sound with frequencies between 40 Hz and 20,000 Hz.

4. The audio device of claim 2, wherein the full range driver is configured to output sound with frequencies between 120 Hz and 16,000 Hz.

5. The audio device of claim 1, wherein the audio input module is an eARC input module configured to extract the center channel audio data from an eARC signal.

6. The audio device of claim 5, comprising a wireless module configured to wirelessly provide left and right channel audio data to external left and right channel speakers, respectively.

7. The audio device of claim 1, further comprising pre-out unamplified RCA outputs configured to provide analog left and right channel audio signals.

8. The audio device of claim 1, further comprising a sub-woofer output port.

9. The audio device of claim 1, further comprising a housing comprising a front face and a recess structure at a bottom of the front face.

10. The audio device of claim 9, further comprising a low frequency port in the recess structure.

11. An audio device, comprising:
an audio input module configured to receive left, right, and center channel audio data from a smart display device;
a center channel speaker;
a left channel output port;
a right channel output port; and
a three-channel amplifier coupled to the between the audio input module and the center channel speaker, the left channel output port, and the right channel output port.

12. The audio device of claim 11, further comprising a digital-to-analog converter coupled between the audio input module and the three-channel amplifier and configured to receive the left, right, and center channel audio data and to output left, right, and center channel analog audio signals to the three-channel amplifier.

13. The audio device of claim 12, wherein the three-channel amplifier is configured to receive the left, right, and center analog audio signals, to generate left, right, and center amplified audio signals, to provide the left, right, and center channel amplified audio signals to the left channel output port, the right channel output port, and the center speaker, respectively.

14. The audio device of claim 11, wherein the center channel speaker comprises a full range driver.

15. The audio device of claim 11, further comprising a sub-woofer output port.

16. The audio device of claim 11, further comprising a housing comprising a front face and a recess structure at a bottom of the front face.

17. The audio device of claim 16, further comprising a low frequency port in the recess structure.

18. The audio device of claim 16, further comprising a slot in a downward facing surface of the recess structure.

19. A passive center channel speaker box, comprising:
a housing comprising a front face and a back face;
a full-range driver mounted in the front face;
center channel input ports mounted in the back face and configured to receive amplified center channel audio signals; and
internal connection wires coupled between the center channel input ports and the full-range driver.

20. The passive center channel speaker box of claim 19, wherein the center channel input ports are the only ports on the back face.

21. The passive center channel speaker box of claim 19, further comprising a passive cross-over network coupled between the internal connection wires.

22. The passive center channel speaker box of claim 19, wherein the housing comprises a bottom face and a recess structure adjoining the bottom face and the front face.

23. The passive center channel speaker box of claim 22, further comprising a low frequency port in the recess structure.

24. The passive center channel speaker box of claim 22, further comprising a finger slot in a downward facing surface of the recess structure.

25. An audio device, comprising:
an audio input module configured to receive left, right, and center channel audio data from a smart display device;
a multi-channel amplifier coupled to the input module;
a left channel output port coupled to the multi-channel amplifier;
a right channel output port coupled to the multi-channel amplifier; and
a center channel output port coupled to the multi-channel amplifier.

26. The audio device of claim 25, wherein the audio input module receives the left, right, and center channel audio data in an eARC audio format.

27. The audio device of claim 25, further comprising a digital-to-analog converter coupled between the audio input module and the multi-channel amplifier, wherein the digital-to-analog converter the left, right, and center channel audio data to left, right, and center channel analog audio signals, respectively.

28. The audio device of claim 27, wherein the multi-channel amplifier receives the left, right, and center channel analog audio signals, generates left, right, and center channel amplified audio signals, and provides the left, right, and center channel amplified audio signals to the left, right, and center channel output ports, respectively.

29. The audio device of claim 28, further comprising a streamer configured to receive audio content via a network connection.

30. The audio device of claim 25, further comprising a sub-woofer output port.

31. A method, comprising:
receiving, at an audio input module of an audio device, multi-channel audio data from a smart display device;
extracting, with the audio input module, center channel audio data from the multi-channel audio data;
converting, with a digital-to-analog converter of the audio device, the center channel audio data to center channel analog audio signals;
generating, with an amplifier of the audio device, center channel amplified audio signals by amplifying the center channel analog audio signals; and
driving a center channel speaker of the audio device with the center channel amplified audio signals.

32. The method of claim 31, wherein the center channel speaker comprises a full range driver.

33. The method of claim 31, comprising:
extracting, with the audio input module, left and right channel audio data from the multi-channel audio data;
converting, with the digital-to-analog converter of the audio device, the left and right channel audio data to left and right channel analog audio signals;
generating, with an amplifier of the audio device, left and right channel amplified audio signals by amplifying the left and right channel analog audio signals; and
providing the left and right channel amplified audio signals to left and right channel output ports of the audio device, respectively.
